(19) United States
(12) Patent Application Publication
(10) Pub. No.: US 2025/0184880 A1
(43) Pub. Date: Jun. 5, 2025

(54) SYSTEMS AND METHODS FOR CONSUMER NETWORK SLICE SELECTION

(71) Applicant: Verizon Patent and Licensing Inc., Basking Ridge, NJ (US)

(72) Inventors: Jae Cho, Demarest, NJ (US); Paul Kania, Branchburg, NJ (US); Garima Garg, Livingston, NJ (US); Lily Zhu, Parsippany, NJ (US); Rachel Elizabeth Page, Mine Hill Township, NJ (US); Jeremy Short, Glen Gardner, NJ (US); Brian T. Mecum, Folsom, CA (US); Lixia Yan, Basking Ridge, NJ (US)

(21) Appl. No.: 18/524,158

(22) Filed: Nov. 30, 2023

(51) Int. Cl. H04W 48/18; H04M 1/72469; H04W 48/16

(52) U.S. Cl. CPC H04W 48/18; H04M 1/72469; H04W 48/16

(57) ABSTRACT

Systems and methods described herein providing consumer-driven access to network slices. A network device receives, from a user device, a slice selection to associate an application on the user device with a network slice. A slice recommender device generates a slice recommendation based on at least one of device parameters or network parameters. The network device provides, to the user device, the slice recommendation for presentation to the user.

### BACKGROUND

Fifth Generation (5G) mobile networks are being deployed as the next evolution of mobile wireless networks. 5G mobile networks are designed to increase data transfer rates, increase spectral efficiency, improve coverage, improve capacity, and reduce latency. For example, a 5G network may incorporate network slicing technology to increase network efficiency and performance. In some cases, access to certain network slices, such as those that provide low latency data transfers and/or high quality of service (QOS), may be offered as an additional feature to premium users.

### BRIEF DESCRIPTION OF THE DRAWINGS

FIG. 1 illustrates concepts described herein;

FIG. 2 is a diagram illustrating a network environment in which systems and methods described herein may be implemented;

FIG. 3 is a diagram of example logical components implemented in a user equipment (UE) device, according to an implementation;

FIG. 4 is a diagram illustrating communications for a slice recommender, according to an implementation;

FIGS. 5-8 illustrate use cases for consumer network slice selection, according to an implementation;

FIG. 9 is a signal flow diagram illustrating a consumer network slice selection, according to an implementation;

FIG. 10 is a process flow diagram for a process for consumer network slice selection; and

FIG. 11 is a diagram illustrating exemplary components of a device that may be included in a component described herein.

### DETAILED DESCRIPTION

The following detailed description refers to the accompanying drawings. The same reference numbers in different drawings may identify the same or similar elements. Also, the following detailed description does not limit the invention.

Systems and methods described herein relate to providing consumer-driven access to network slices. User equipment (UE) devices may execute various applications that generate network traffic with different service requirements. These different service requirements may be met through network slicing. A network slice refers to a complete logical network that includes, for example, components of a Radio Access Network (RAN) and a Core Network, which provide certain telecommunication services and network capabilities that can vary from slice to slice. Selection of network slices for a particular application can thus have significant impact on network performance and user experience.

While applications can benefit from optimal slice allocation, mobile network operators (MNOs) are not currently privy to certain application slicing information. For example, MNOs may not have access to what specific application is using a network slice. MNOs can benefit from providing greater slice selection control to users (e.g., users of applications on the UE devices) who can make informed decisions to associate an application with a network slice. Systems and methods described herein provide slice recommendations to a user of an application and enable the user to act on the recommendation. The slice recommendation may advise a user of improved service that is available for an application through a network slice and inform the user of inefficient slice selections.

As used herein, the term “user” is intended to be broadly interpreted to include a user device or a user of a user device. Also, the term “user,” “consumer,” and “subscriber” may be used interchangeably. Furthermore, the term “subscription” is intended to refer to a network services subscription unless otherwise indicated.

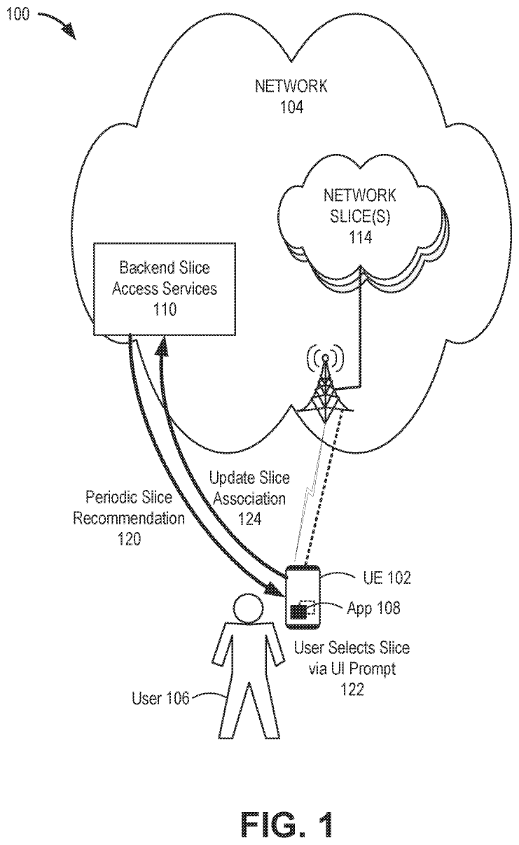

FIG. 1 illustrates an overview of the concepts described herein. As shown, a network 104 (e.g., a mobile network, also referred to herein as a provider network) is configured to provide communications-related services to a UE device 102. UE device 102 (also referred to herein as user devices) may execute one or more applications (e.g., App 108) that may use network slices 114.

Network slices 114 employ a virtual network architecture that enables multiple logical networks to be implemented on top of a shared physical network infrastructure using software defined networking (SDN) and/or network function virtualization (NFV). Each logical network, referred to as a “network slice,” may encompass an end-to-end virtual network with dedicated or shared storage and/or computational resources that include access network components, clouds, transport, central processing unit (CPU) cycles, memory, etc. Furthermore, each network slice 114 may be configured to meet a different set of requirements and be associated with a particular QoS class, a type of service, and/or a particular group of customers associated with mobile communication devices.

According to an implementation, one or more network slices 114 may be configured to provide premium services (e.g., low latency, high QoS, high bandwidth, etc.) for which a user subscription is required. For example, for optimal performance, an app 108 (e.g., a real-time gaming app, etc.) on UE device 102 may require guaranteed low latency that is not always available over standard network connections. If a user/subscriber does not have a subscription to a particular network slice (e.g., a network slice providing premium service), an application (e.g., app 108) cannot use that network slice and may default to a non-premium network slice or default Internet traffic connection, for example.

According to implementations described herein, UE device 102 may include a slice selection menu that allows a user to associate each application 108 with a network slice (e.g., a default slice, a low latency slice, a high bandwidth slice, etc.). Recommendations may be provided from network 104 to help the user make appropriate slice selections. Each application 108 may be initially configured to a default (e.g., basic) slice, for example. Backend slice access services 110 in network 104 may monitor slice activity and provide periodic recommendations, such as to upgrade to a different slice for improved performance, to downgrade to another slice for network efficiency, or to update a user's service subscription to allow access to a premium network slice. For example, application 108 may be configured for a default network slice and, when launched, may request to establish a connection with the default network slice. As shown in FIG. 1, devices in network 104 may identify the user's network slice subscription status, determine whether the default slice is best suited for the application 108, and send to UE device 102 a slice recommendation 120 for app 108. As described further herein, according to an implementation, slice recommendation 120 may be provided to application 108 using UE Route Selection Policy (URSP) rules.

Based on slice recommendation 120, UE device 102 may prompt the user 106 to switch to the recommended network slice. Assuming the user has a subscription for a recommended network slice, UE device 102 may provide a prompt for the user 106 to simply accept or reject the recommended slice. Assuming the user does not have a subscription for a network slice recommended for application 108, UE device 102 may prompt user 106 to subscribe to a service level that includes the network slice. As described further herein, according to different implementations, UE device 102 may provide an on-screen prompt via application 108 or a UE device operating system. User 106 may select the recommended slice via the user interface (UI) prompt, as indicated by reference 122. In response, UE device 102 may instruct the network 104 to update 124 the slice association for application 108.

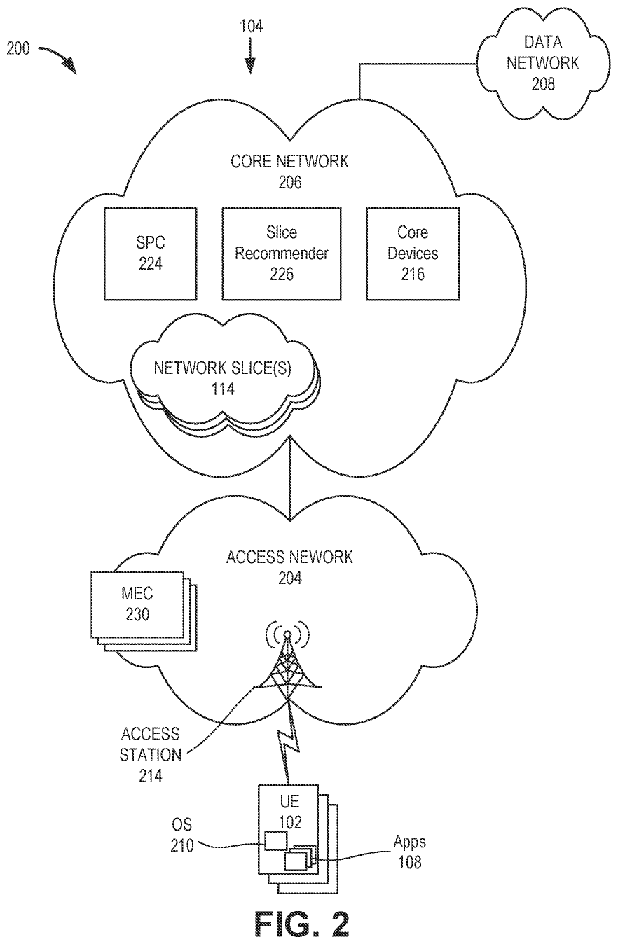

FIG. 2 illustrates an example network environment 200 in which the systems and methods described herein may be implemented. As shown, environment 200 may include one or more UE devices 102 (generically and individually referred to as “UE device 102”), network 104, and a data network 208. Network 104 may include an access network 204 and a core network 206.

UE device 102 may include a wireless communication device, a mobile terminal, or a fixed wireless access (FWA) device. Examples of UE device 102 include a smart phone; a tablet device; a wearable computer device (e.g., a smart watch); a laptop computer; an autonomous vehicle with communication capabilities; a portable gaming system; and an Internet-of-Thing (IoT) device. In some implementations, UE device 102 may correspond to a wireless Machine-Type-Communication (MTC) device that communicates with other devices over a machine-to-machine (M2M) interface, such as Long-Term-Evolution for Machines (LTE-M) or Category M1 (CAT-M1) devices and Narrow Band (NB)-IoT devices. UE device 102 may send packets to or over access network 204.

One or more applications 108 on UE device 102 may be configured for optimal performance using a preferred network slice, which an MNO of network 104 may offer as a service with an additional subscription. UE device 102 may also include an operating system (OS) 210. As described further herein, operating system 210 may provide an interface with network 104 to enable user selection of network slices for each app 108. Operating system 210 may also provide network 104 with user-selected slice settings for each application.

Access network 204 may allow UE device 102 to connect to core network 206, data network 208, and other devices associated with or included in network 104 (e.g., another UE device 102). To do so, access network 204 may establish and maintain, with participation from UE device 102, an over-the-air channel with UE device 102; and maintain backhaul channels with core network 206. Access network 204 may convey information through these channels, from UE device 102 to core network 206 and vice versa. Access network 204 may include a 5G radio network (e.g., a 5G New Radio (NR) network), a 4G radio network (e.g., an evolved Universal Mobile Telecommunications Service (UMTS) Terrestrial Network (eUTRAN)), and/or another advanced radio network. These radio networks may operate in many different frequency ranges, including millimeter wave (mmWave) frequencies, sub 6 GHz frequencies, and/or other frequencies. Access network 204 may include multiple access stations, one of which is shown as access station 214.

Access station 214 may include a 5G, 4G, or another type of access station (e.g., a wireless station, a base station, an evolved Node B (eNB), a next generation Node B (gNB), a Central Unit (CU), a Distributed Unit (DU), a Radio Units (RU), etc.). Some access stations 214 may include Radio Frequency (RF) transceivers for wireless or cellular communication. In some implementations, access station 214 may include Integrated Access and Backhaul (IAB) nodes (not shown). Access station 214 may establish and maintain an over-the-air channel with UE device 102 and backhaul channels with core network 206.

Access network 204 may include one or more Multi-Access Edge Computing (MEC) clusters 230. MEC cluster 230 may be located geographically close to access stations 214 and, therefore, also be close to UE devices 102 serviced by the access station 214. Due to its proximity to UE devices 102, MEC cluster 230 may be capable of providing services to UE devices 102 with minimal latency. Thus, MEC functions may be included in one of more of network slices 114. Depending on the implementations, a MEC cluster 230 may provide many core network functions at network edges. In other implementations, a MEC cluster 230 may be positioned at other locations (e.g., in core network 206) at which the MEC cluster 230 can provide computational resources for improved performance.

Core network 206 may include 5G core network components, a combination of 4G and 5G core network components, or another type of core network components. Examples of 5G core network components include a User Plane Function (UPF), an Application Function (AF), an Access and Mobility management Function (AMF), a Session Management Function (SMF), a Unified Data Management (UDM) function, a Network Slice Selection Function (NSSF), and a Policy Control Function (PCF). Examples of 4G core network components include a Serving Gateway (SGW), a Packet data network Gateway (PGW), and a Mobility Management Entity (MME). Core network 206 may allow the delivery of Internet Protocol (IP) services to UE device 102, and may interface with other networks, such as data network 208.

In FIG. 2, core network 206 is shown as including network slices 114, core devices 216, a subscriber profile controller (SPC) 224, and slice recommender 226. SPC 224 and slice recommender 226 may be part of backend slice access services 110. In different embodiments, however, some of these components also may be implemented on access network 204 and/or MEC cluster 230. Access network 204, core network 206, and MEC cluster 230 may include multiple instances of network slices 114, core devices 216, SPC 224, slice recommender 226, and/or other core network components.

Network slices 114 may be instantiated as a result of network slicing. According to an implementation, one or more network slices 114 may be configured to provide premium services (e.g., low latency, QoS, etc.) for which a user subscription is required. Network slices 114 are associated with and may be identified by Network Slice Selection Assistance Information (NSSAI). A single network slice 114 may be identified by a Single-NSSAI (S-NSSAI).

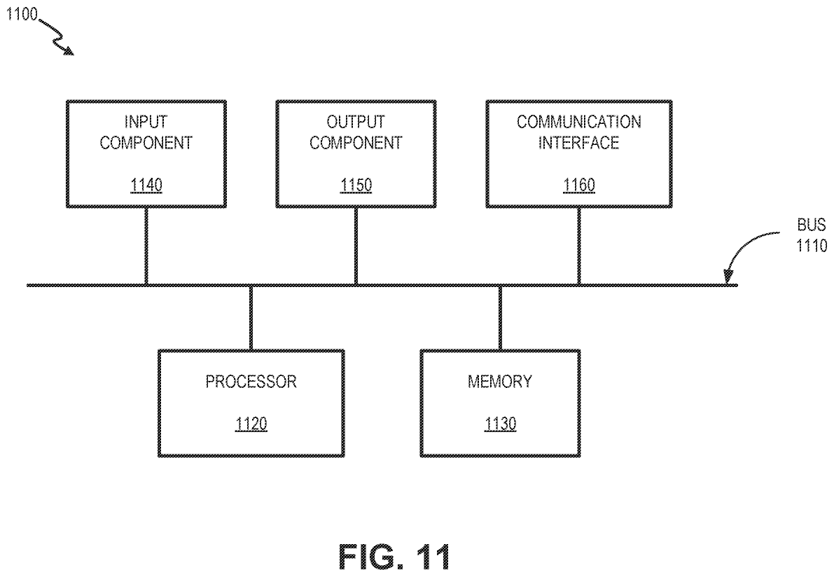

Core network 206 may include core devices 216. Core device 216, as described above, may include a 5G network function; a 4G network node; a transport network device, such as, for example, a switch, router, firewall, gateway, an optical switching device (e.g., a reconfigurable optical add-drop multiplexer, etc.), and/or another type of network device. Core device 216 may include a physical function node or a virtual network function (VNF). Thus, the components of core network 206 may be implemented as dedicated hardware components and/or as VNFs implemented on top of a common shared physical infrastructure using Software Defined Networking (SDN). For example, an SDN controller may implement one or more of the components of core network 206 using an adapter implementing a VNF virtual machine, a Containerized Network Function (CNF), an event driven serverless architecture interface, and/or another type of SDN architecture. The common shared physical infrastructure may be implemented using one or more devices 1100 described below with reference to FIG. 11 in a cloud computing center associated with core network 206. Additionally, or alternatively, some or all of the common shared physical infrastructure may be implemented using devices in MEC 230.

SPC 224 and slice recommender 226 may be part of backend slice access services 110. SPC may include one or more network devices to authenticate the identity of users and store information which identifies actions that users/subscribers are authorized to perform. SPC 224 may identify whether a user subscription provides access to a preferred network slice (e.g., a network slice 114 providing premium services). In one implementation, if there is no subscription for the preferred network slice, SPC 224 may cause UE device 102 to prompt the user to inquire whether the user wants to subscribe to a premium network slice. If a network slice subscription is successful, application 108 may be provided with an access token for the network slice.

SPC 224 may issue access tokens, also referred to as authorization tokens, for certain network slices 114 upon successful verification of user identities. The authorization framework may use an authorization layer such as OAuth 2.0 for credentials grant. The access tokens may be based on Java Script Object Notation (JSON) web tokens (JWTs) secured using digital signatures or Message Authentication Codes based on JSON Web Signature (JWS). SPC 224 may access user profile information from, for example, a subscription server and/or a provisioning platform (not shown) included in, for example, backend slice access services 110.

Slice recommender 226 may include a network device and/or network function that determines if an application (e.g., app 108) should be using a current network slice or make a recommendation to switch to another slice. Slice recommender 226 may receive UE device 102 parameters and may also receive network capability and performance information from a network (e.g., network 104). Based on the parameters, slice recommender 226 may determine whether a different network slice is needed to support the application performance requirements. According to some exemplary embodiments, slice recommender 226 may include artificial intelligence (AI) and/or machine learning (ML) logic that may analyze and predict operational characteristics of the network, such as performance metrics, key performance indicators (KPIs), and so forth. Slice recommender 226 may interface and coordinate with SPC 224, as described further herein. Slice recommender 226 may be configured to learn user traffic patterns and recommend optimal slices for different user types.

Data network 208 may include networks that are external to core network 206. In some implementations, data network 208 may include packet data networks, such as an IP network or another type of network. For example, data network 208 may include a local area network (LAN), a wide area network (WAN), a metropolitan area network (MAN), an optical network, a cable television network, a satellite network, a wireless network (e.g., a Code Division Multiple Access (CDMA) network, a general packet radio service (GPRS) network, an LTE network (e.g., a 4G network), a 5G network, an ad hoc network, a telephone network (e.g., the Public Switched Telephone Network (PSTN), an intranet, or a combination of networks. In other implementation, data network may include an application server or other network device to support applications 108 executed on UE devices 102/

For simplicity, FIG. 2 does not show all components that may be included in network 104 (e.g., routers, bridges, wireless access point, additional networks, access stations 214, MEC clusters, etc.). Depending on the implementation, network 104 may include additional, fewer, different, or a different arrangement of components than those illustrated in FIG. 2. Furthermore, in different implementations, the configuration of network 104 may be different.

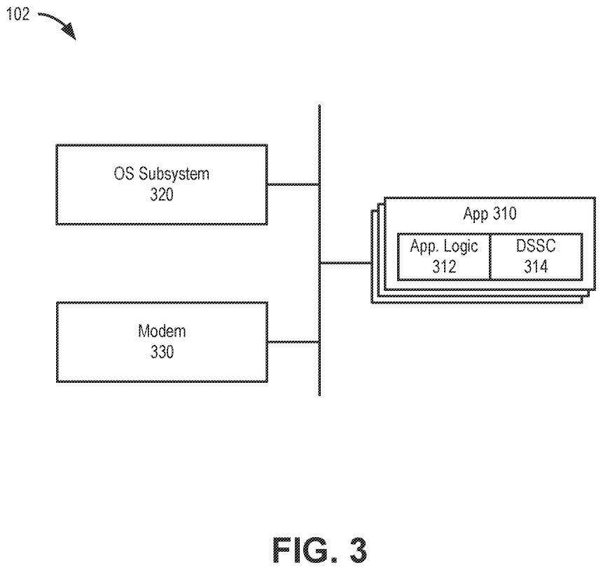

FIG. 3 illustrates logical components of UE device 102 according to an implementation. As shown in FIG. 3, UE device 102 may include client applications 310, an operating system (OS) subsystem 320, and a modem 330. In an implementation, all or some of the components illustrated in FIG. 3 may be implemented by a processor (e.g., processor 1120 of FIG. 11) executing software instructions stored in a memory (e.g., memory 1130 of FIG. 11). In other implementations, some or all of the components illustrated in FIG. 3 may be implemented in hardware or a combination of hardware, firmware and software used to perform the functionality described below.

Client applications 310 may include applications (e.g., software) running on UE device 102. Client applications 310 may correspond to one of applications 108. For example, a client application 310 may include a video streaming application, a web browser, a gaming application, etc. Some client applications 310 may require relatively high uplink and/or downlink throughput/bandwidth for an optimal user experience. Such client applications 310 make use of network slicing, and, more particularly, a network slice 114 providing premium services. Other client applications 310 may not have requirements for any particular network slice and may generate data processed as default Internet traffic. According to an embodiment, client applications 310 may include logic that provides a service pertaining to an application server residing in data network 208. For example, client applications 310 may provide a gaming service, gambling service, financial service, streaming service, shopping service, social media service, etc., for a user of UE device 102. Client applications 310 may request (e.g., based on configuration settings or an application server request) a network slice 114 providing premium services.

OS subsystem 320 may establish a connection (e.g., an IP connection) between client application 310 and modem 330. In implementations described herein, OS subsystem 320 may communicate traffic descriptor values from client applications 310 to modem 330. For example, OS subsystem 320 may be configured to receive an access token from client application 310 for a network slice and provide the token value to modem 330. In some implementations, OS subsystem 320 may also provide a governance function to confirm that client application 310 is authorized to use the new traffic descriptor value. According to an implementation described herein, OS subsystem 320 may provide a slice selection menu to permit users to associate each application with a network slice.

Modem 330 may manage the physical layer and connectivity for UE device 102. Modem 330 may include, for example, a 5G/NR modem that performs processing, modulation, demodulation, and/or other signal processing for 5G/NR communications of UE device 102. Modem 330 may store URSP rules and/or access the URSP rules from a subscriber identity module (SIM), a SIM-like device, or another secure element (not shown) of UE device 102. According to implementations described herein, modem 330 may receive updated URSP rules from core network 206 in response to a subscription change or menu selection for a network slice.

Although FIG. 3 shows exemplary logical components of UE device 102, in other implementations, UE device 102 may include fewer components, different components, differently arranged components, or additional components than depicted in FIG. 3. In addition, functions described as being performed by one of the logical components in FIG. 3 may alternatively be performed by another one or more of the components of UE device 102.

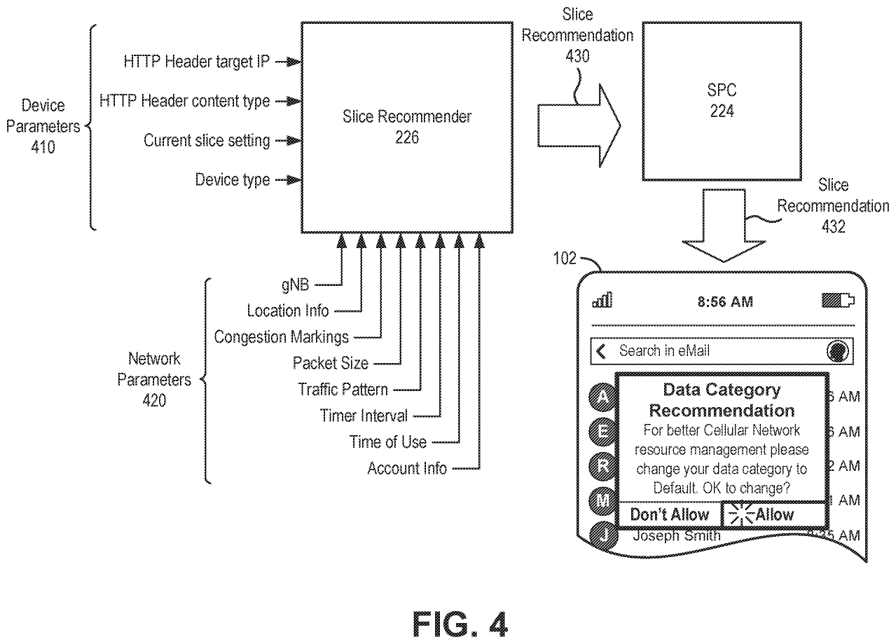

FIG. 4 is a diagram illustrating inputs and communications for slice recommender 226. As shown in FIG. 4, slice recommender 226 may receive device parameters 410 and network parameters 420. Generally, slice recommender 226 may process device parameters 410 and network parameters 420 using machine learning, for example, to generate a slice recommendation 430 for a specific application and subscriber under current (or predicted) network conditions and/or other factors.

Device parameters 410 may include device-side information related to a specific UE device 102 and application session. Device parameters 410 may include, for example, a hyper-text transfer protocol (HTTP) header target IP address (e.g., a packet header indicating a packet destination), an HTTP header content type (e.g., a mime-type), a current slice setting (e.g., based on a user selection of network slice descriptors via menu 530 described below and provided via the OS subsystem 320), and a device type (e.g., indicating whether UE device 102 has hardware to support network slicing). In some instances, device parameters 410 may be obtained from packet data from UE device 102 and provided to slice recommender 226 by, for example, other devices in backend slice access services 110 or other core devices 216. In another implementation, device parameters 410 may include additional parameters. According to an implementation, OS subsystem 320 may provide some or all of device parameters 410 during periodic polling intervals.

Network parameters 420 may include network-side information related to a specific UE device 102 and application session. Network parameters 420 may include, for example, an access station (e.g., gNodeB) servicing UE device 102, location information of UE device 102 (e.g., indicating a longitude and latitude), congestion markings (e.g., an Explicit Congestion Notification (ECN) or other marking), a packet size (e.g., as observed by the network, which may indicate a data chunk, handshake, etc.), a traffic pattern, a timer interval (e.g., length of a session, which may differentiate between a single download or a streaming session), a time of use (e.g., morning, evening, etc.), and UE account information (e.g., a premium service subscription versus a basic subscription). In another implementation, network parameters 420 may include additional parameters. Network parameters 420 may be obtained from access station 214 and/or core devices 216, for example.

Slice recommender 226 may apply service parameters 410 and/or network parameters 420 to, for example, a machine learning model and identify what slice is best-suited for the current application. Slice recommender 226 may generate a slice recommendation 430, which may be provided to SPC 224. SPC 224 may, in turn, provide the slice recommendation 432 to UE device 102, as illustrated in FIG. 4.

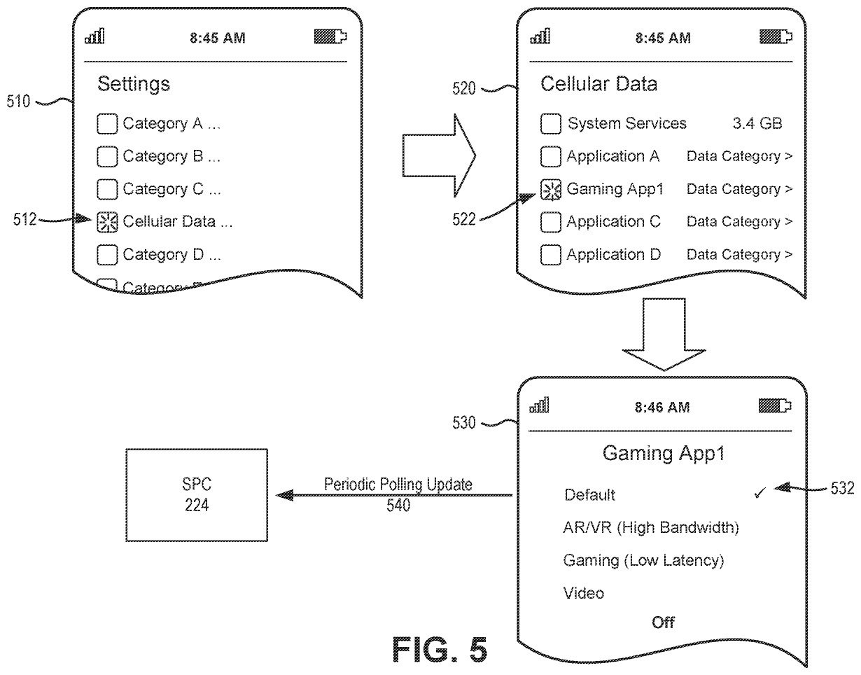

FIG. 5 is a diagram illustrating a use case for implementing consumer network slice selection. More particularly, FIG. 5 illustrates an example menu system (e.g., user interfaces) that may be presented for a user of UE device 102 to present and/or select network slice options.

Assume UE device 102 receives initial slice information from core network 206 via a URSP push. Within a Setting menu 510, UE device 102 (e.g., OS subsystem 320) may provide an option 512 for Cellular Data settings. Upon selection of the Cellular Data settings option 512, UE device 102 may present Cellular Data menu 520. Cellular Data menu 520 may include a list of applications (e.g., applications 108) on UE device 102 that for which access to a user's cellular service subscription may be controlled and/or used to provide service for the applications. In contrast with conventional controls that may simply enable or disable cellular data access for selected applications, Cellular Data menu 520 may allow different data categories (e.g., network slices) to be associated with each application in Cellular Data menu 520.

In the example of FIG. 5, assume a user selects option 522 for Gaming App1. Selection of option 522 may cause UE device 102 to present Slice Selection menu 530. Slice Selection menu 530 may list network slice descriptors that are available for use with the selected application (e.g., Gaming App1, in the example of FIG. 5). Slice descriptors for available network slices for a particular application may include, for example, a default slice, a high bandwidth slice, a low latency slice, and a video streaming slice. The list of available network slices in menu 530 may include any network slice 114 available to consumers. In another implementation, the list of available network slices in menu 530 may include only network slices 114 to which a user is subscribed. An indicator 532 may identify the network slice to which the application is currently assigned. In one implementation, new applications may initially be assigned to a default slice. The current slice section (and corresponding application ID) from menu 530 may be provided to SPC 224 via a setEntitlement call for example. As described further herein, a user may select another option from menu 530 to change the network slice association for the application.

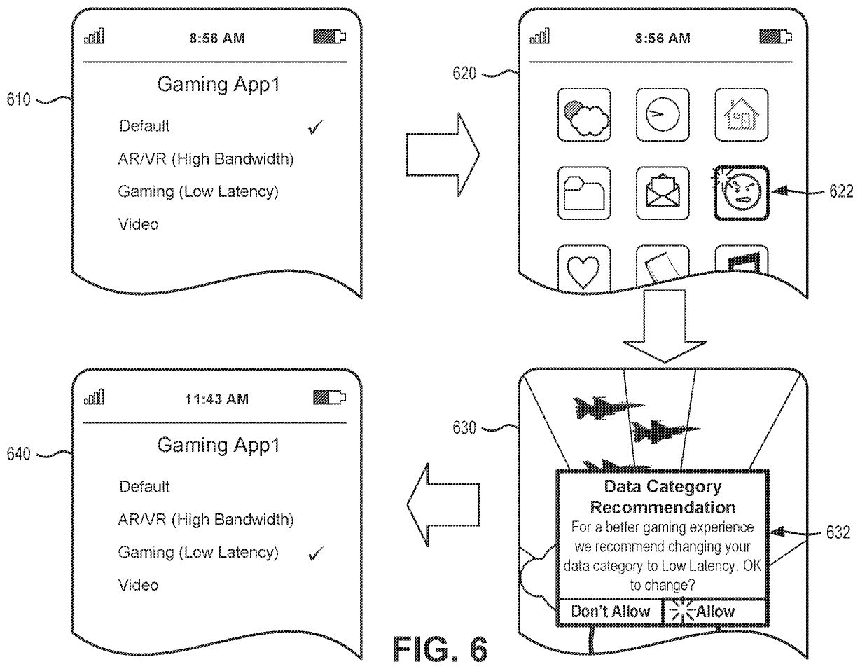

FIG. 6 is a diagram illustrating a use case for implementing consumer network slice selection. More particularly, FIG. 6 illustrates a process where a user on a premium subscription plan may be prompted to upgrade a slice selection for a gaming application. FIG. 6 provides a simplified illustration of communications to/from UE device 102 and is not intended to reflect every signal, communication, or intermediate exchanges between functions/devices.

In FIG. 6, assume the application Gaming App1 is initially associated with a default network slice, as indicated by the check mark in Slice Selection menu 610. Slice recommender 226 may determine that Gaming App1 needs a low latency slice for the best user experience and may provide a recommendation to SPC 224. At some polling interval after the application is installed, SPC 224 will send to UE device 102 a getEntitlement message, which will include a slice recommendation for “Gaming App1” to use slice “Low Latency” slice.

A user may use main menu 620 and select icon 622 to launch Gaming App1, which would be set to use the default slice based the original (or latest) slice assignment (e.g., from menu 610). Upon launching the selected application with the default slice, UE device 102 can detect that “low latency” is the recommended network slice for Gaming App1. UE device 102 may provide menu 630 and prompt 632 with a recommendation to set the slice to “low latency,” which is already available to the user due to the premium subscription plan. The user may select the “Allow” option in prompt 632, which may cause UE device 102 to automatically update the slice configuration for Gaming App1 to “Low Latency.” At the polling interval after the user's selection, UE device 102 will send to SPC 224 a setEntitlement message, which will include the updated slice selection for “Gaming App1” to the “Low Latency” slice. All traffic for Gaming App1 may now be configured to travel over the “Low Latency” slice. As shown in FIG. 6, a user may later return to Slice Selection menu 640 to confirm the changed network slice association.

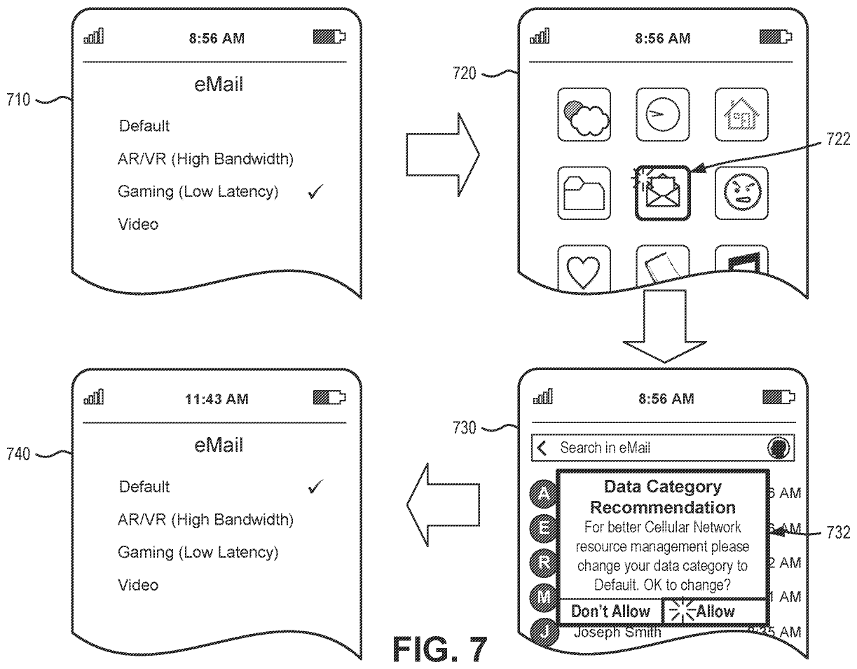

FIG. 7 is a diagram illustrating another use case for implementing consumer network slice selection. More particularly, FIG. 7 illustrates a process where a user on a premium subscription plan may be prompted to downgrade a slice selection for an email application. FIG. 7 provides a simplified illustration of communications to/from UE device 102 and is not intended to reflect every signal, communication, or intermediate exchanges between functions/devices.

In FIG. 7, assume the application eMail has been configured (e.g., via a user selection) to use a low latency network slice, as indicated in Slice Selection menu 710, and the selection is reported to SPC 224. SPC 224 may send this information to slice recommender 226, where the slice recommender 226 will consider various parameters such as location, type of app, to make a slice recommendation for the eMail application. In this example, slice recommender 226 may determine that the eMail application does not need a low latency slice for the best user experience and may provide a recommendation for a default slice to SPC 224. At a subsequent polling interval, SPC 224 will send to UE device 102 a getEntitlement message, which will include a slice recommendation for “eMail” to use slice “default” slice.

A user may use main menu 720 and select icon 722 to launch the eMail application, which would be set to use the low latency slice based the latest slice assignment (e.g., from menu 710). Upon launching the selected application, UE device 102 can detect that “default” is recommended network slice for the eMail application. UE device 102 may provide menu 730 and prompt 732 with a recommendation to set the slice to “default.” The user may select the “Allow” option in prompt 732, which may cause UE device 102 to automatically update the slice configuration for the eMail application to “default.” At the polling interval after the user's selection, UE device 102 will send to SPC 224 a setEntitlement message, which will include the updated slice selection for “eMail” to the “default” slice. All traffic for the eMail application may now be configured to travel over the “default” slice. As shown in FIG. 7, a user may later return to Slice Selection menu 740 to confirm the changed network slice association.

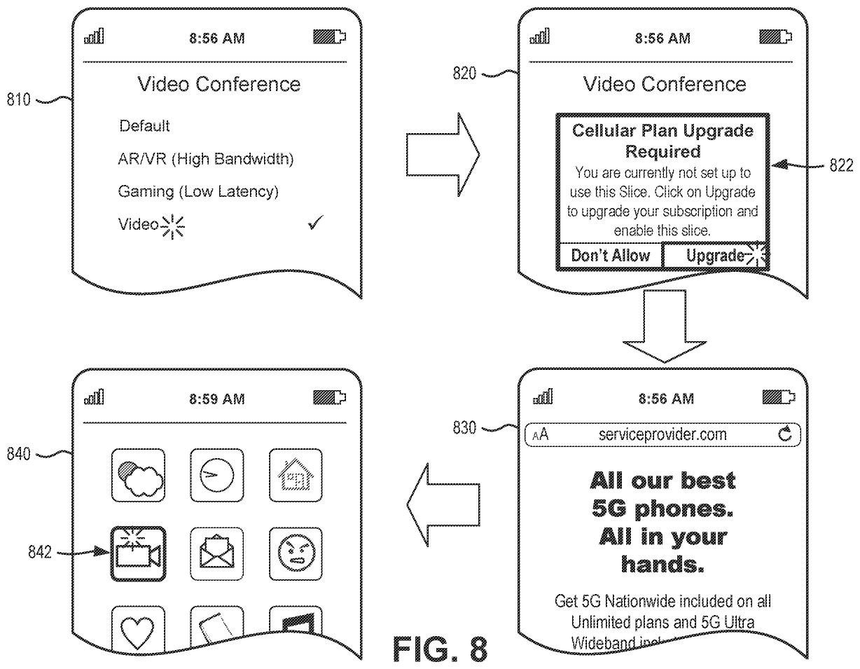

FIG. 8 is a diagram illustrating still another use case for implementing consumer network slice selection. More particularly, FIG. 8 illustrates a process where a user without a premium subscription plan may be prompted to upgrade a subscription to enable an optimal slice selection. FIG. 8 provides a simplified illustration of communications to/from UE device 102 and is not intended to reflect every signal, communication, or intermediate exchanges between functions/devices.

In FIG. 8, assume a videoconferencing application, Video Conference, is initially associated with a default network slice and a user attempts to use the Slice Selection menu to change the slice association to “Video,” as indicated in Slice Selection menu 810. The selection may be reported to SPC 224 (e.g., via a setEntitlement call), and SPC 224 may determine that the user does not have a subscription to access a video slice. For example, SPC 224 may query a user profile to determine that the user does not have a premium subscription that grants access to a video slice. SPC 224 may inform UE device 102 that the user is not authorized to access the video slice.

In response to the indication from SPC 224, UE device 102 may provide menu 820 and prompt 822 with a recommendation to upgrade to a premium subscription plan. The user may select the “Upgrade” option in prompt 822, which may cause UE device 102 to launch a browser window 830 or application to facilitate the subscription upgrade. After completing the subscription upgrade, the user may launch the videoconferencing application. For example, a user may use main menu 840 and select icon 842 to launch the Video Conference application, which would use the Video slice based on the latest slice assignment.

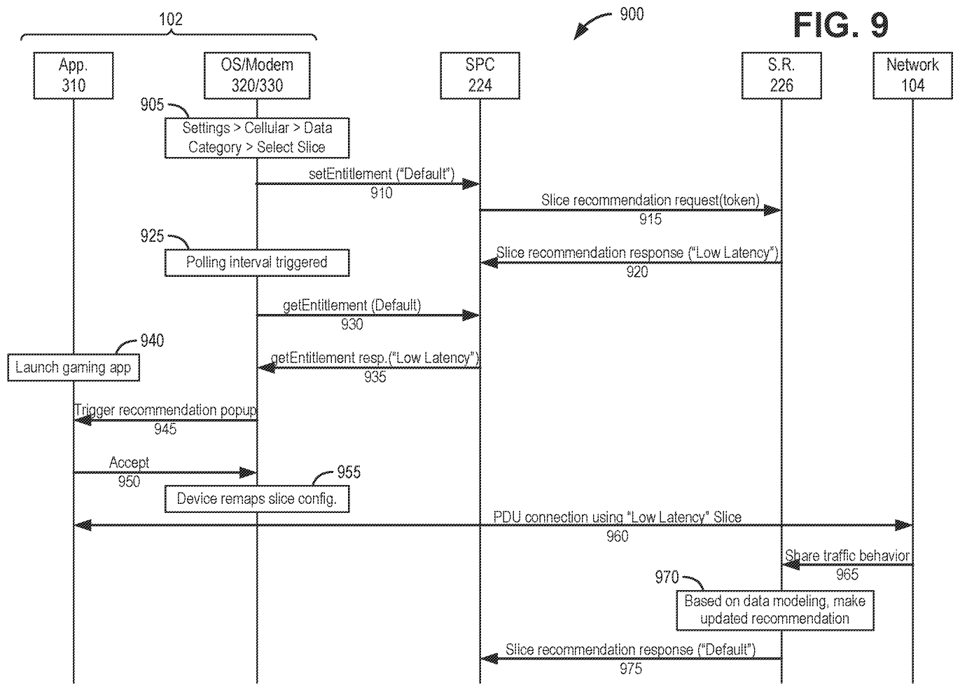

FIG. 9 is a signal flow diagram illustrating consumer network slice selection in a portion 900 of network environment 200, according to an implementation. Network portion 900 may include UE device 102, slice recommender 226, SPC 224, and network 104. FIG. 9 provides a simplified illustration of communications in network portion 900 and is not intended to reflect every signal, communication, or intermediate points for exchanges between functions/devices. Communications in FIG. 9 may correspond to the use case described above in connection with FIG. 6.

As shown at block 905 in FIG. 9, a user may use the slice selection menu (e.g., menu 610) of UE device 102 to associate a network slice (e.g., Default, High Bandwidth, Gaming, Video, etc.) with an application (e.g., application 310). Assume in FIG. 9 the user selects or maintains the “Default” slice selection. Based on the user's selection, UE device 102 may provide a setEntitlement message 910 to SPC 224. The setEntitlement message may include an authorization token previously issued by SPC 224. According to an implementation, setEntitlement message 910 may include, along with the authorization token, a slice selection (e.g., “Default”). Thus, setEntitlement message 910 may indicate a currently assigned slice and what slice a user intends to change to to support application 310.

SPC 224 may receive setEntitlement message 910. In response, SPC 224 may verify the token and provide a slice recommendation request 915 with the token to slice recommender 226. Slice recommender 226 may apply a machine learning algorithm to decide whether application 310 should continue to use the current (e.g., Default) slice or whether slice recommender 226 should make a recommendation to switch to a different network slice. Assume slice recommender 226 determines that application 310 would be better serviced via a low latency slice. Slice recommender 226 may provide to SPC 224 a slice recommendation response 920 recommending application 310 should change to a “Low Latency” slice.

At the next polling interval 925, UE device 102 may provide a getEntitlement message 930 to SPC 224. The getEntitlement message may include the authorization token and the current slice selection (e.g., “Default”). SPC 224 may receive getEntitlement message 930 and, based on slice recommendation response 920, SPC 224 may provide a getEntitlement response 935 recommending the Low Latency slice for application 310.

At some time after receiving getEntitlement response 935, a user may launch 940 application 310. UE device 102 (e.g., OS subsystem 320) may trigger 945 application 310 to present a recommendation popup menu (e.g., prompt 632), based on getEntitlement response 935. Assuming positive input from the user (i.e., elect to allow the recommended slice change), application 310 may relay 950 the user input (e.g., “Accept”) to OS subsystem 320, which may remap 955 the slice configuration for application 310 from “Default” to “Low Latency.” Application 310 may then establish a protocol data unit (PDU) session 960 over network 104 using the low latency slice.

Network 104 may monitor traffic behavior for application 310 over PDU session 960 (e.g., traffic associated with application token). At periodic intervals, network 104 may share 965 with slice recommender 226 the traffic behavior data associated with the token. Slice recommender 226 may also apply a machine learning algorithm to decide whether application 310 should stay on the current (e.g., Low Latency) slice or whether slice recommender 226 should make a recommendation to switch to a different network slice (970). Assume slice recommender 226 determines that, based on the accumulated and/or current traffic data, the Default slice will meet service requirements for application 310. Slice recommender 226 may provide to SPC 224 a slice recommendation response 975 recommending that application 310 should change back to the “Default” slice. SPC 224 may receive slice recommendation response 975 and may store the recommendation for responding to a future getEntitlement message from UE device 102.

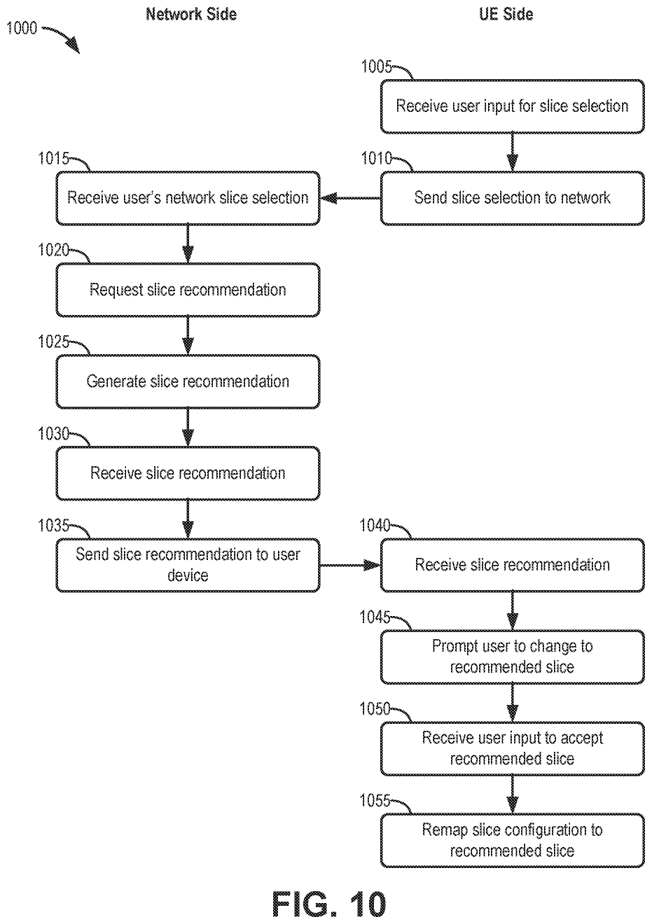

FIG. 10 is a flow diagram of a process 1000 for providing consumer-driven access to network slices, according to an implementation. In one implementation, process 1000 may be implemented by UE device 102 and SPC 224. In another implementation, process 1000 may be implemented SPC 224 and slice recommender 226 in conjunction with UE device 102.

Process 1000 may include receiving user input for a slice selection (block 1005) and sending the slice selection to a network (block 1010). For example, UE device 102 may provide a slice selection menu (e.g., menu 530) to allow a user to associate an application with a network slice. The user may make a selection or maintain a default selection. UE device 102 may provide the selection input to SPC 224. In one implementation the selection input may identify the application, the current slice, and the selected slice. In another implementation, UE device 102 may provide a token to mask (e.g., prevents disclosure of) the actual application ID.

Process 1000 may further include receiving the user's network slice selection (block 1015), requesting a slice recommendation (block 1020), and generating a slice recommendation (block 1025). For example, SPC 224 may receive from UE device 102 a user's network slice selection to associate an application (application 310) on the user device with a network slice. SPC 224 may request, from slice recommender 226, a recommended network slice for the application. Slice recommender 226 may generate a slice recommendation based on a combination of device parameters (e.g., device parameters 410) and network parameters (e.g., network parameters 420).

Process 1000 may also include receiving the slice recommendation (block 1030) and sending the slice recommendation to the user device (block 1035). For example, SPC 224 may receive from slice recommender 226 the slice recommendation for the application and may provide, to the UE device 102, the slice recommendation for presentation to the user.

Process 1000 may additionally include receiving the slice recommendation (block 1040), prompting the user to change to the recommended slice (block 1045), receiving user input to accept the recommended slice (block 1050), and remapping the slice configuration to the recommended slice (block 1055). For example, UE device 102 may receive from SPC 224 a message indicating the different recommended network slice to associate with the application. UE device 102 may present to a user a menu to solicit a change to the recommended different network slice. UE device 102 may receive user input to accept the recommended different network slice and may remap, based on the user input, the slice configuration for the application. Components of core network 206 and access network 204 may then use the selected network slice to service the application 310.

FIG. 11 illustrates example components of a device 1100 according to an implementation described herein. Components of UE device 102, backend slice access services 110, access station 214, core devices 216, SPC 224, slice recommender 226, and other network devices in network 104 may each include or be implemented on one or more devices 1100. Device 1100 may include a bus 1110, a processor 1120, a memory 1130, an input component 1140, an output component 1150, and a communication interface 1160.

Bus 1110 may include a path that permits communication among the components of device 1100. Processor 1120 may include a processor, a microprocessor, or processing logic that may interpret and execute instructions. Memory 1130 may include any type of dynamic storage device that may store information and instructions, for execution by processor 1120, and/or any type of non-volatile storage device that may store information for use by processor 1120. Input component 1140 may include a mechanism that permits a user to input information to device 1100, such as a keyboard, a keypad, a button, a switch, etc. Output component 1150 may include a mechanism that outputs information to the user, such as a display, a speaker, one or more light emitting diodes (LEDs), etc. For example, in the context of UE device 102, output component 1150 may include a display to selectively present menus (e.g., menus 510, 620, 730, etc.), as described herein.

Communication interface 1160 may include a transceiver that enables device 1100 to communicate with other devices and/or systems via wireless communications, wired communications, or a combination of wireless and wired communications. For example, communication interface 1160 may include mechanisms for communicating with another device or system via a network. Communication interface 1160 may include an antenna assembly for transmission and/or reception of RF signals. For example, communication interface 1160 may include one or more antennas to transmit and/or receive RF signals over the air. In one implementation, for example, communication interface 1160 may communicate with a network and/or devices connected to a network. Alternatively, or additionally, communication interface 1160 may be a logical component that includes input and output ports, input and output systems, and/or other input and output components that facilitate the transmission of data to other devices.

Device 1100 may perform certain operations in response to processor 1120 executing software instructions contained in a computer-readable medium, such as memory 1130. A computer-readable medium may be defined as a non-transitory memory device. A memory device may include space within a single physical memory device or spread across multiple physical memory devices. The software instructions may be read into memory 1130 from another computer-readable medium or from another device. The software instructions contained in memory 1130 may cause processor 1120 to perform processes described herein. Alternatively, hardwired circuitry may be used in place of or in combination with software instructions to implement processes described herein. Thus, implementations described herein are not limited to any specific combination of hardware circuitry and software.

Although FIG. 11 shows exemplary components of device 1100, in other implementations, device 1100 may contain fewer components, additional components, different components, or differently arranged components than those depicted in FIG. 11. For example, device 1100 may include one or more switch fabrics instead of, or in addition to, bus 1110. Additionally, or alternatively, one or more components of device 1100 may perform one or more tasks described as being performed by one or more other components of device 1100.

Systems and methods described herein providing consumer-driven access to network slices. A network device may receive, from a user device, a user's network slice selection to associate an application on the user device with a network slice and may request, from a slice recommender device, a recommended network slice for the application. The slice recommender device may generate a slice recommendation based on a combination of device parameters and network parameters. The network device may receive, from the slice recommender device, the slice recommendation for the application and may provide, to the user device, the slice recommendation for presentation to the user.

According to another embodiment, a user device may receive user input to associate an application on the user device with a network slice and may send, to a network device, an indication of the user selection. The user device may receive, from the network device, a message indicating a recommended different network slice to associate with the application and may provide, to a user, a menu to solicit a change to the recommended different network slice. The user device may receive user input to accept the recommended different network slice and may remap, based on the user input, the slice configuration for the application.

The foregoing description of implementations provides illustration and description, but is not intended to be exhaustive or to limit the invention to the precise form disclosed. Modifications and variations are possible in light of the above teachings or may be acquired from practice of the invention. Also, while a series of signals and blocks have been described regarding FIGS. 9 and 10, the order of the blocks and message/operation flows may be modified in other embodiments. Further, non-dependent blocks may be performed in parallel. In addition, while particular menus have been illustrated, it should be understood that other menus may be used to solicit input for premium or non-premium network slice services.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving, by a network device and from a user device, a slice selection to associate an application on the user device with a network slice;
generating, by a slice recommender device, a slice recommendation for the application based on at least one of device parameters or network parameters; and
providing, by the network device and to the user device, the slice recommendation for presentation to a user.

2. The method of claim 1, wherein receiving the slice selection includes:
providing, to the user via the user device, a slice selection menu, and
receiving user input via the slice selection menu.

3. The method of claim 2, wherein the slice selection menu includes options for the user to associate a network slice descriptor with individual applications on the user device.

4. The method of claim 1, wherein receiving the slice selection includes:
receiving an access token that prevents disclosure of an application ID of the application.

5. The method of claim 1, wherein receiving the slice selection includes:
receiving an application ID for the application.

6. The method of claim 1, wherein generating the slice recommendation includes:
generating a slice recommendation based on a location of the user device.

7. The method of claim 1, wherein generating the slice recommendation includes:
generating a slice recommendation based on a content type indicated in a packet header.

8. The method of claim 1, wherein generating the slice recommendation includes:
generating the slice recommendation for the application based on predicted network conditions.

9. The method of claim 1, further comprising:
receiving, by the network device, a different slice recommendation from the slice recommender device; and
providing, by the network device and to the user device, the different slice recommendation for presentation to the user.

10. A system comprising:
at least one network device including a processor configured to:
receive, from a user device, a slice selection to associate an application on the user device with a network slice;
generate, a slice recommendation based on at least one of device parameters or network parameters; and
provide, to the user device, the slice recommendation for presentation to a user.

11. The system of claim 10, wherein, when generating the slice recommendation, the processor is further configured to:
generate the slice recommendation based on a location of the UE device.

12. The system of claim 10, wherein, when generating the slice recommendation, the processor is further configured to:
generate a slice recommendation based on a content type indicated in an HTTP header.

13. The system of claim 10, wherein, when receiving the slice selection, the processor is further configured to:
receive an access token that prevents disclosure of an application ID of the application.

14. The system of claim 10, wherein, when receiving the slice selection, the processor is further configured to:
receive an application ID for the application.

15. The system of claim 10, wherein, when generating the slice recommendation, the processor is further configured to:
generate the slice recommendation for the application based on predicted network conditions.

16. The system of claim 10, wherein the processor is further configured to:
generate a different slice recommendation than a current slice associated with the application; and
provide to the user device, the different slice recommendation for presentation to the user.

17. A non-transitory, computer-readable storage media storing instructions, which, when executed by one or more processors of a device, cause the device to:
receive from a user device, a slice selection to associate an application on the user device with a network slice;
generate a slice recommendation based on at least one of device parameters or network parameters; and
provide, to the user device, the slice recommendation for presentation to a user.

18. The non-transitory, computer-readable storage media of claim 17, wherein the instructions to generate the slice recommendation further comprise instructions to cause the device to:
generate the slice recommendation based on a location of the UE device; or
generate the slice recommendation based on a content type indicated in an HTTP header.

19. The non-transitory, computer-readable storage media of claim 17, wherein the instructions to generate the slice recommendation further comprise instructions to cause the device to:
generate the slice recommendation for the application based on predicted network conditions.

20. The non-transitory, computer-readable storage media of claim 17, further comprising instructions to cause the device to:
generate an updated slice recommendation; and
provide to the user device, the updated slice recommendation for presentation to the user.
